(19) United States
(12) Patent Application Publication
(10) Pub. No.: US 2011/0284727 A1
(43) Pub. Date: Nov. 24, 2011

(54) CCD CHARGE TRANSFER DRIVE DEVICE

(75) Inventors: Yoshio KONISHI, Osaka (JP); Naohisa HATANI, Kyoto (JP); Makoto KAWAJIRI, Kyoto (JP)

(73) Assignee: PANASONIC CORPORATION, Osaka (JP)

(21) Appl. No.: 13/111,264

(22) Filed: May 19, 2011

(30) Foreign Application Priority Data
May 20, 2010 (JP) 2010-115998

(51) Int. Cl. G01J 1/44

(52) U.S. Cl. 250/214 P

(57) ABSTRACT

A CCD charge transfer drive device includes: a timing signal generation unit that generates a first timing signal group including N timing signals representing CCD drive pulses; a control signal generation unit that generates a first control signal when a level change of any of the N timing signals is detected, the first control signal indicating a first enable period that is k times as long as one cycle of a system clock signal (k is an integer that is equal to or larger than N/2 and is closest to N/2); a time-division multiplexing unit that time-division multiplexes the N timing signals in the first enable period by time-division multiplexing two signals per cycle of the system clock signal; and a demultiplexing unit that demultiplexes the time-division multiplexed signal into the N timing signals.

### BACKGROUND OF THE INVENTION

(1) Field of the Invention

The present invention relates to a time-division multiplexing circuit that time-division multiplexes a plurality of signals, and a signal transmission device including the time-division multiplexing circuit.

(2) Description of the Related Art

To reduce the number of signal lines between a drive timing generation circuit for a CCD solid-state imaging device and a drive pulse generation circuit that outputs a drive pulse based on an output signal of the drive timing generation circuit (that is, to reduce the number of terminals of each circuit), a multiplex transmission method whereby a plurality of signals are time-division multiplexed and transmitted is known. For example, Japanese Unexamined Patent Application Publication No. 2003-8995 discloses a CCD charge transfer drive device including a time-division multiplexing circuit and a demultiplexing circuit. This CCD charge transfer drive device includes: a timing signal generation circuit that supplies a plurality of timing signals (a plurality of read pulse timing signals and a plurality of vertical transfer timing signals); and a vertical drive circuit that outputs a plurality of vertical drive pulses for driving a vertical transfer unit of a solid-state imaging device (such as a CCD image sensor) based on the plurality of timing signals supplied from the timing signal generation circuit. The time-division multiplexing circuit and the demultiplexing circuit are respectively provided in the timing signal generation circuit and the vertical drive circuit. The time-division multiplexing circuit time-division multiplexes the plurality of read pulse timing signals and the plurality of vertical transfer timing signals to generate a plurality of multiplexed signals. The demultiplexing circuit demultiplexes the plurality of multiplexed signals into the plurality of read pulse timing signals and the plurality of vertical transfer timing signals.

### SUMMARY OF THE INVENTION

In the time-division multiplexing circuit in Japanese Unexamined Patent Application Publication No. 2003-8995, however, there are timing constraints of signal changes between input signals to be multiplexed. In detail, consider the case of time-division multiplexing two input signals. When, while one input signal is being selected to be multiplexed, the other input signal changes in signal level, the two input signals cannot be properly multiplexed. That is, only input signals in a specific relation (for example, a read pulse timing signal and a vertical transfer timing signal) can be multiplexed with each other. This makes it difficult to enhance the effect of reducing the number of signal lines (the number of terminals of each circuit) by time-division multiplexing. For instance, in the case of a CCD charge transfer drive device, the number of read pulse timing signals is typically smaller than the number of vertical transfer timing signals. In the time-division multiplexing circuit in Japanese Unexamined Patent Application Publication No. 2003-8995, the number of timing signals that can be subjected to multiplexing is restricted to the number of read pulse timing signals, thus posing a difficulty in enhancing the effect of reducing the number of signal lines. There is also a problem that the number of signals to be multiplexed is limited to two, because a polarity of a read pulse timing signal is used for switching a multiplexed signal that is fed to a common line.

In view of this, the present invention has an object of providing a time-division multiplexing circuit and a signal transmission device that can multiplex three or more signals, by alleviating timing constraints of signal changes between input signals to be multiplexed.

To solve the conventional problems stated above, a CCD charge transfer drive device according to one aspect of the present invention is a CCD charge transfer drive device that drives a solid-state imaging device including: a plurality of light receiving elements arranged two-dimensionally; a plurality of vertical CCDs; and a horizontal CCD, the CCD charge transfer drive device including: a timing signal generation unit that generates a first timing signal group that includes N timing signals representing CCD drive pulses; a change detection unit that detects a level change of any of the N timing signals; a control signal generation unit that generates a first control signal when the change detection unit detects the level change of any of the N timing signals, the first control signal indicating a first enable period that is k times as long as one cycle of a system clock signal, where k is an integer that is equal to or larger than N/2 and is closest to N/2; a time-division multiplexing unit that time-division multiplexes the N timing signals in the first enable period by time-division multiplexing two signals per cycle of the system clock signal, to generate a first time-division multiplexed signal; a decode clock generation unit that generates a decode clock used for demultiplexing; and a demultiplexing unit that demultiplexes the first time-division multiplexed signal into the N timing signals, using the decode clock.

According to this structure, in the first enable period that is k times as long as one cycle of the system clock signal (k is an integer that is equal to or larger than N/2 and is closest to N/2, and N is the number of timing signals), two signals are time-division multiplexed per cycle of the system clock signal. Thus, the number of signals to be multiplexed can be set to an arbitrary number equal to or larger than three. This improves flexibility in the number of signals to be time-division multiplexed.

Here, the CCD charge transfer drive device may include: a one-chip first semiconductor device; and a one-chip second semiconductor device, wherein the first semiconductor device includes the timing signal generation unit, the change detection unit, the control signal generation unit, the decode clock generation unit, and the time-division multiplexing unit, and the second semiconductor device includes the demultiplexing unit, and supplies the N timing signals to the solid-state imaging device.

According to this structure, since a CCD drive pulse typically requires a high voltage, the second semiconductor device that supplies the timing signals to the solid-state imaging device can be operated with a high voltage, whereas the first semiconductor device that generates and multiplexes the timing signals can be operated with a low voltage.

Here, the control signal generation unit may generate the first control signal indicating the first enable period, only when the change detection unit detects the level change of any of the N timing signals, wherein the time-division multiplexing unit time-division multiplexes the N timing signals, only in the first enable period indicated by the first control signal, and the demultiplexing unit demultiplexes the first time-division multiplexed signal, only in the first enable period indicated by the first control signal.

According to this structure, the N timing signals are not constantly multiplexed, but multiplexed only when a level change is detected. This contributes to power saving.

Here, the timing signal generation unit may further generate a second timing signal group that includes M timing signals of a lower rate than the first timing signal group, wherein the change detection unit further detects a level change of any of the M timing signals, the control signal generation unit further generates a second control signal when the change detection unit detects the level change of any of the M timing signals, the second control signal indicating a second enable period that is h times as long as one cycle of the system clock signal, where h is an integer that is equal to or larger than M/2 and is closest to M/2, the time-division multiplexing unit further time-division multiplexes the M timing signals in the second enable period by time-division multiplexing two signals per cycle of the system clock signal, to generate a second time-division multiplexed signal, and the demultiplexing unit further demultiplexes the second time-division multiplexed signal into the M timing signals.

According to this structure, the number N of signals to be multiplexed as the first timing signal group and the number M of signals to be multiplexed as the second timing signal group can be separately determined. When the number of signals to be multiplexed is larger, a longer period (enable period) is required for multiplexing. Therefore, the number of signals to be multiplexed can be increased for timing signals of a lower rate (lower frequency). Conversely, when the number of signals to be multiplexed is smaller, a shorter period (enable period) is required for multiplexing. Therefore, the number of signals to be multiplexed can be decreased for timing signals of a higher rate (higher frequency). In other words, by classifying timing signals into the first timing signal group and the second timing signal group according to the timing signal rate, a multiplexed signal obtained by multiplexing a smaller number of higher-rate timing signals and a multiplexed signal obtained by multiplexing a larger number of lower-rate timing signals can both be generated, with it being possible to balance the required rate and the number of signals to be multiplexed.

Here, M may be larger than N.

According to this structure, by classifying the N higher-rate timing signals as the first timing signal group and the M lower-rate timing signals as the second timing signal group, it is possible to balance the required rate and the number of signals to be multiplexed for each of the first and second timing signal groups.

Here, the first timing signal group may be a timing signal group for transfer operations of the plurality of vertical CCDs, wherein the second timing signal group is a timing signal group for signal charge reading operations from the plurality of light receiving elements to the plurality of vertical CCDs.

According to this structure, since the transfer operations of the plurality of vertical CCDs are faster than the signal charge reading operations from the plurality of light receiving elements to the plurality of vertical CCDs, an appropriate balance can be achieved between the required rate and the number of signals to be multiplexed for each of the first and second timing signal groups.

Here, the control signal generation unit may further generate a third control signal indicating a third enable period that is represented by logical OR of the first enable period and the second enable period, wherein the time-division multiplexing unit: time-division multiplexes the N timing signals included in the first timing signal group in the third enable period by time-division multiplexing two signals per cycle of the system clock signal, to generate the first time-division multiplexed signal; and time-division multiplexes the M timing signals included in the second timing signal group in the second enable period by time-division multiplexing two signals per cycle of the system clock signal, to generate the second time-division multiplexed signal, and the demultiplexing unit, based on the third control signal, demultiplexes the first time-division multiplexed signal into the N timing signals, and demultiplexes the second time-division multiplexed signal into the M timing signals.

According to this structure, the first timing signal group with a smaller number of signals to be multiplexed is multiplexed in the third enable period. The third enable period is represented by logical OR of the first enable period and the second enable period. Meanwhile, the second timing signal group with a larger number of signals to be multiplexed is multiplexed in the second enable period. This makes it possible to reduce the number of signal lines between the time-division multiplexing unit and the demultiplexing unit. In particular, in the case where the time-division multiplexing unit and the demultiplexing unit are formed as semiconductor devices of separate chips, the number of terminals of each semiconductor device can be reduced, which contributes to lower cost.

Moreover, a semiconductor device according to one aspect of the present invention is a semiconductor device that generates CCD drive pulses for a solid-state imaging device including: a plurality of light receiving elements arranged two-dimensionally; a plurality of vertical CCDs; and a horizontal CCD, the semiconductor device including: a timing signal generation unit that generates N timing signals that represent the CCD drive pulses, where N is an integer equal to or larger than three; a change detection unit that detects a level change of any of the N timing signals; a control signal generation unit that generates a first control signal when the change detection unit detects the level change of any of the N timing signals, the first control signal indicating a first enable period that is k times as long as one cycle of a system clock signal, where k is an integer that is equal to or larger than N/2 and is closest to N/2; a time-division multiplexing unit that time-division multiplexes the N timing signals in the first enable period by time-division multiplexing two signals per cycle of the system clock signal, to generate a first time-division multiplexed signal; and a decode clock generation unit that generates a decode clock used for demultiplexing.

Moreover, a semiconductor device according to one aspect of the present invention is a semiconductor device that generates CCD drive pulses for a solid-state imaging device including: a plurality of light receiving elements arranged two-dimensionally; a plurality of vertical CCDs; and a horizontal CCD, the semiconductor device including: a reception unit that receives a first time-division multiplexed signal generated by time-division multiplexing N timing signals representing the CCD drive pulses, where N is an integer equal to or larger than three; and a demultiplexing unit that demultiplexes the first time-division multiplexed signal into the N timing signals in a first enable period that is k times as long as one cycle of a system clock signal where k is an integer that is equal to or larger than N/2 and is closest to N/2, the N timing signals having been time-division multiplexed by time-division multiplexing two signals per cycle of the system clock signal.

Moreover, a CCD charge transfer drive device according to one aspect of the present invention is a CCD charge transfer drive device including a first semiconductor device and a second semiconductor device, wherein the first semiconductor device includes: a timing signal generation unit that generates timing signals for CCD drive pulses; and a unit that detects a change of the timing signals and generates a time-division multiplexed signal of the timing signals, a decode control signal (first control signal), and a decode clock, the second semiconductor device includes: a demultiplexing unit that receives the multiplexed signal, the decode control signal, and the decode clock, and demultiplexes the multiplexed signal into the original timing signals; and a CCD drive pulse generation unit that receives the timing signals obtained by demultiplexing, and the multiplexed signal is transmitted between the first and second semiconductor devices. Signal multiplexing and demultiplexing can be performed in a period of the decode control signal, so that the number of signals multiplexed and transmitted through one signal line can be increased.

Moreover, for each of two or more timing signal groups classified according to a duration from one level change to the next level change of each timing signal, a multiplexing unit that multiplexes a different number of signals of the corresponding timing signal group is provided. This allows multiplexing of an optimum number of signals for a level change frequency of the signals. Thus, timing constraints of signal changes between input signals to be multiplexed can be alleviated, which improves flexibility in time-division multiplexing.

Note that, in the case of providing a multiplexing unit for each of two or more different numbers of signals, by redundantly performing time-division multiplexing and demultiplexing, the number of decode control signals transmitted from the multiplexing units to the demultiplexing unit can be reduced.

As described above, timing constraints of signal changes between input signals to be multiplexed can be alleviated. This improves flexibility in the number and combination of signals to be time-division multiplexed.

### FURTHER INFORMATION ABOUT TECHNICAL BACKGROUND TO THIS APPLICATION

The disclosure of Japanese Patent Application No. 2010-115998 filed on May 20, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram schematically showing a CCD charge transfer drive device according to a first embodiment of the present invention;

FIG. 2 is a block diagram showing the CCD charge transfer drive device shown in FIG. 1, as semiconductor devices;

FIG. 3 is a diagram showing a structure example of a multiplexing unit shown in FIG. 1;

FIG. 4A is a diagram showing a structure example of a signal change detection unit shown in FIG. 3;

FIG. 4B is a timing chart when any of signals to be multiplexed changes in polarity, in the signal change detection unit shown in FIG. 4A;

FIG. 4C is a timing chart when the signals to be multiplexed change in polarity simultaneously, in the signal change detection unit shown in FIG. 4A;

FIG. 5A is a diagram showing a structure example of a control signal generation unit shown in FIG. 3;

FIG. 5B is a timing chart when any of the signals to be multiplexed changes in polarity, in the control signal generation unit shown in FIG. 5A;

FIG. 5C is a timing chart when the signals to be multiplexed change in polarity simultaneously, in the control signal generation unit shown in FIG. 5A;

FIG. 6A is a diagram showing a structure example of an output switching unit shown in FIG. 3;

FIG. 6B is a timing chart showing an operation of the output switching unit shown in FIG. 6A;

FIG. 7A is a diagram showing a structure example of a decode clock generation unit shown in FIG. 1;

FIG. 7B is a timing chart showing an operation of the decode clock generation unit shown in FIG. 7A;

FIG. 8 is a diagram showing a structure example of a demultiplexing unit shown in FIG. 1;

FIG. 9A is a diagram showing a structure example of a decode timing control unit shown in FIG. 8;

FIG. 9B is a timing chart showing an operation of the decode timing control unit shown in FIG. 9A;

FIG. 10A is a diagram showing a structure example of an input switching unit shown in FIG. 8;

FIG. 10B is a timing chart showing an operation of the input switching unit shown in FIG. 10A;

FIG. 11 is a block diagram schematically showing a CCD charge transfer drive device according to a second embodiment of the present invention;

FIG. 12 is a diagram showing a structure example of multiplexing units shown in FIG. 11;

FIG. 13 is a timing chart when time-division multiplexing units shown in FIG. 12 perform multiplexing;

FIG. 14 is a diagram showing a structure example of a demultiplexing unit shown in FIG. 11;

FIG. 15 is a timing chart when the demultiplexing unit shown in FIG. 14 performs demultiplexing;

FIG. 16 is a block diagram schematically showing a CCD charge transfer drive device according to a third embodiment of the present invention;

FIG. 17 is a timing chart when multiplexing units shown in FIG. 16 perform multiplexing; and

FIG. 18 is a timing chart when a demultiplexing unit shown in FIG. 16 performs demultiplexing.

### DESCRIPTION OF THE PREFERRED EMBODIMENT(S)

The following describes embodiments of the present invention in detail, with reference to drawings. Note that the same or corresponding parts in the drawings are given the same reference numerals, and their description is not repeated.

### First Embodiment

A first embodiment of the present invention describes a CCD charge transfer drive device that time-division multiplexes N timing signals in an enable period that is about N/2 times as long as one cycle of a system clock signal, by time-division multiplexing two signals per cycle of the system clock signal.

This CCD charge transfer drive device is a CCD charge transfer drive device that drives a solid-state imaging device including: a plurality of light receiving elements arranged two-dimensionally; a plurality of vertical CCDs; and a horizontal CCD, the CCD charge transfer drive device including: a timing signal generation unit that generates a first timing signal group that includes N timing signals representing CCD drive pulses; a change detection unit that detects a level change of any of the N timing signals; a control signal generation unit that generates a first control signal when the change detection unit detects the level change of any of the N timing signals, the first control signal indicating a first enable period that is k times as long as one cycle of a system clock signal, where k is an integer that is equal to or larger than N/2 and is closest to N/2; a time-division multiplexing unit that time-division multiplexes the N timing signals in the first enable period by time-division multiplexing two signals per cycle of the system clock signal, to generate a first time-division multiplexed signal; a decode clock generation unit that generates a decode clock used for demultiplexing; and a demultiplexing unit that demultiplexes the first time-division multiplexed signal into the N timing signals, using the decode clock.

Thus, the CCD charge transfer drive device has a feature of time-division multiplexing a plurality of (N) timing signals in the first enable period by time-division multiplexing two signals per cycle of the system clock signal. Thus, the number N of signals to be multiplexed can be set to an arbitrary number equal to or larger than three. This improves flexibility in the number of signals to be multiplexed.

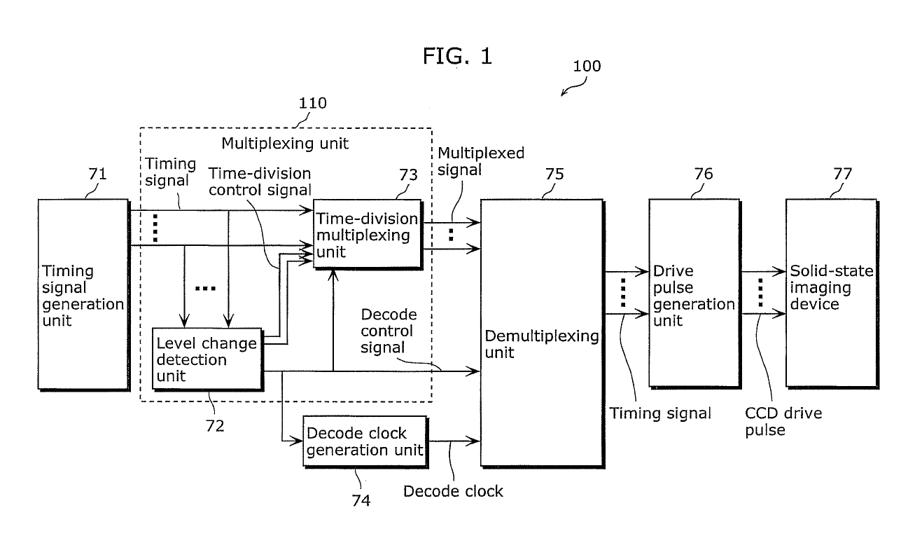

FIG. 1 is a block diagram schematically showing the CCD charge transfer drive device according to the first embodiment of the present invention. A CCD charge transfer drive device 100 shown in FIG. 1 includes: a timing signal generation unit 71 that generates timing signals for driving a CCD solid-state imaging device 77; a multiplexing unit 110 that detects a change of the timing signals and, only when the change is detected, generates a time-division multiplexed signal of the timing signals and a decode control signal for demultiplexing the multiplexed signal into the original timing signals; a decode clock generation unit 74 that generates a decode clock for demultiplexing the multiplexed signal into the original timing signals; a demultiplexing unit 75 that demultiplexes the multiplexed signal into the original timing signals based on the multiplexed signal, the decode control signal, and the decode clock; and a drive pulse generation unit 76 that generates CCD drive pulses based on the demultiplexed timing signals. The CCD charge transfer drive device 100 drives the solid-state imaging device 77 by the CCD drive pulses.

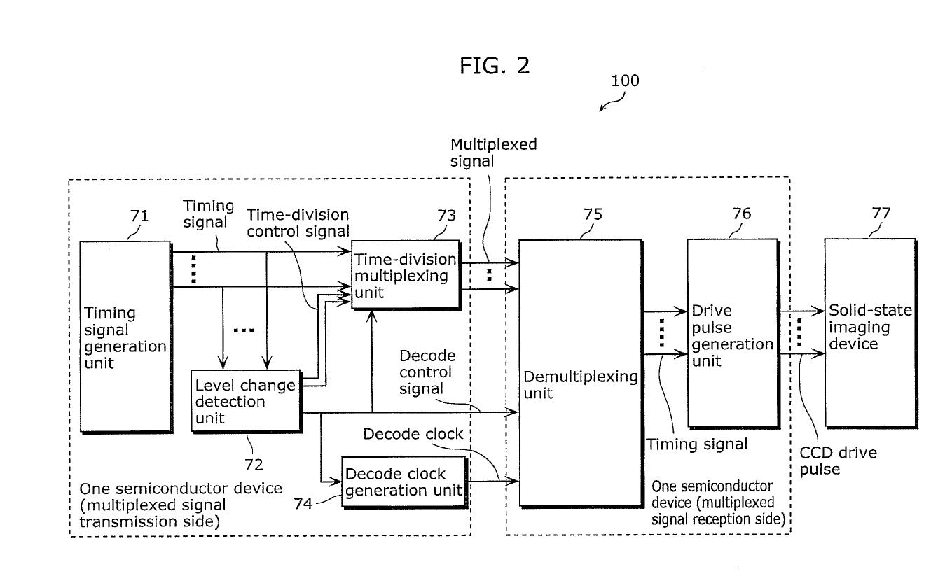

FIG. 2 is a block diagram showing the CCD charge transfer drive device according to the present invention, as semiconductor devices. The timing signal generation unit 71, a level change detection unit 72, a time-division multiplexing unit 73, and the decode clock generation unit 74 are included in one semiconductor device, whereas the demultiplexing unit 75 and the drive pulse generation unit 76 are included in one semiconductor device. Multiplexed signal transmission is performed between the two semiconductor devices according to the present invention.

That is, the CCD charge transfer drive device may include a one-chip first semiconductor device and a one-chip second semiconductor device, wherein the first semiconductor device includes the timing signal generation unit 71, the level change detection unit 72 (including a signal change detection unit and a control signal generation unit), and the time-division multiplexing unit 73, and the second semiconductor device includes the demultiplexing unit 75, and supplies N timing signals obtained by demultiplexing to the solid-state imaging device. According to this structure, since a CCD drive pulse typically requires a high voltage, the second semiconductor device that supplies the timing signals to the solid-state imaging device can be operated with a high voltage, whereas the first semiconductor device that generates and multiplexes the timing signals can be operated with a low voltage.

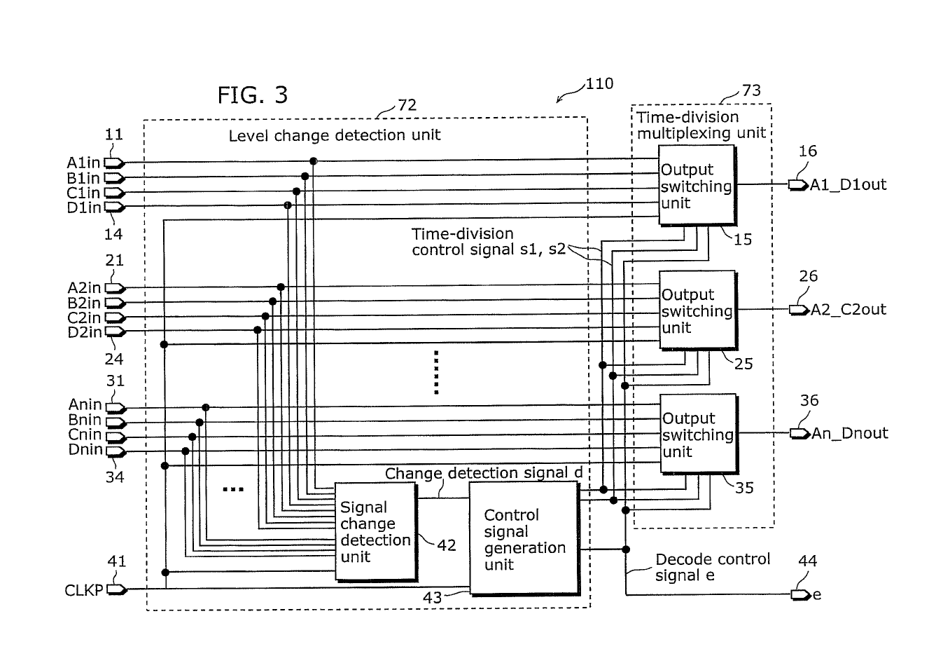

FIG. 3 is a diagram showing a structure example of the multiplexing unit 110 according to the first embodiment of the present invention. The multiplexing unit 110 includes the level change detection unit 72 including a signal change detection unit 42 and a control signal generation unit 43, and the time-division multiplexing unit 73 including output switching units 15, 25, and 35. Input signals include signals 11, 12, 13, 14, 21, 22, 23, 24, 31, 32, 33, and 34 to be multiplexed, and a system clock 41. Output signals include multiplexed signals 16, 26, and 36, and a decode control signal 44. Though the signal change detection unit is composed of one block in FIG. 3, the signal change detection unit may be composed of two or more blocks. Likewise, though the output switching unit is composed of three blocks in FIG. 3, the output switching unit may be composed of two or less blocks, or four or more blocks.

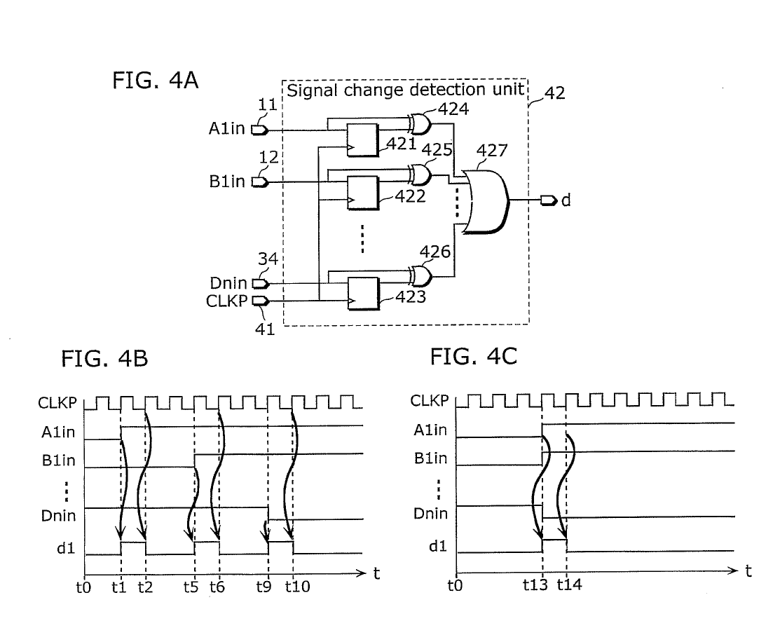

FIG. 4A is a diagram showing a circuit example of the signal change detection unit 42 according to the first embodiment of the present invention. The signal change detection unit 42 includes flip-flops (FFs) 421, 422, . . . , 423, exclusive OR circuits (EXORs) 424, 425, . . . , 426, and an OR circuit 427. Input signals include the signals 11, 12, . . . , 34 to be multiplexed, and the system clock 41. Output signals include a change detection signal d. Though outputs of the EXORs 424, 425, . . . , 426 are operated by one OR circuit 427 in FIG. 4A, the OR circuit may be divided into a plurality of OR circuits.

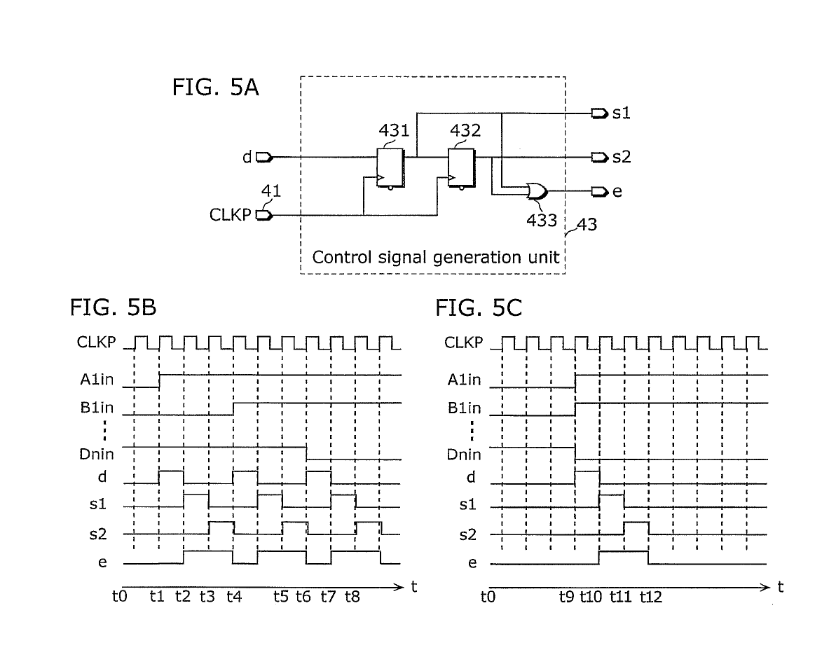

FIG. 5A is a diagram showing a circuit example of the control signal generation unit 43 according to the first embodiment of the present invention. The control signal generation unit 43 includes FFs 431 and 432 and an OR circuit 433. Input signals include the change detection signal d and the system clock 41. Output signals include time-division control signals s1 and s2 and a decode control signal e.

FIG. 5A shows the circuit example when multiplexing four timing signals. When multiplexing N timing signals, the control signal generation unit 43 includes k FFs, instead of the two FFs 431 and 432 in FIG. 5A. Here, k is an integer that is equal to or larger than N/2 and is closest to N/2. For example, when multiplexing two timing signals, k=1, so that the control signal generation unit 43 includes one FF. When multiplexing three timing signals, k=2, so that the control signal generation unit 43 includes two FFs (as shown in FIG. 5A). When multiplexing eight timing signals, k=4, so that the control signal generation unit 43 includes four FFs.

The decode control signal e which is a first control signal indicates the first enable period that is k times as long as one cycle of the system clock signal (k is an integer that is equal to or larger than N/2 and is closest to N/2, and N is the number of timing signals). The decode control signal e has a pulse width corresponding to the first enable period. The first enable period denotes a period in which multiplexing is to be performed in the time-division multiplexing unit 73, and a period in which demultiplexing is to be performed in the demultiplexing unit 75.

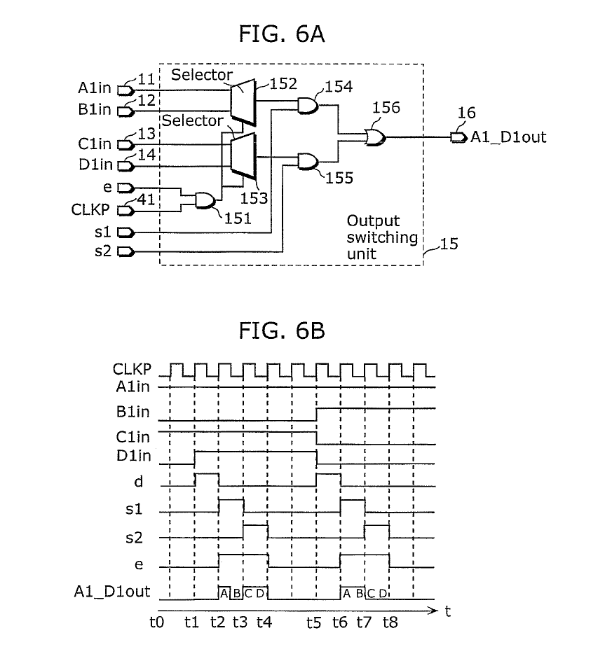

FIG. 6A is a diagram showing a circuit example of the output switching unit 15 according to the first embodiment of the present invention. The output switching unit 15 includes AND circuits 151, 154, and 155, an OR circuit 156, and selectors 152 and 153. Input signals include the signals 11, 12, 13, and 14 to be multiplexed, the decode control signal e, the system clock 41, and the time-division control signals s1 and s2. Output signals include the multiplexed signal 16.

FIG. 6A shows the circuit example when multiplexing four timing signals. When multiplexing N timing signals, the output switching unit 15 includes k selectors and k AND circuits, instead of the two selectors 152 and 153 and the two AND circuits 154 and 155 in FIG. 6A. Here, k is as defined above. For example, when multiplexing two timing signals, k=1, so that the output switching unit 15 includes one selector and one AND circuit. In this case, the OR circuit 156 is omitted. When multiplexing three timing signals, k=2, so that the output switching unit 15 has the structure shown in FIG. 6A. When multiplexing eight timing signals, k=4, so that the output switching unit 15 includes four selectors and four AND circuits, and also the OR circuit 156 is changed to a four-input OR circuit.

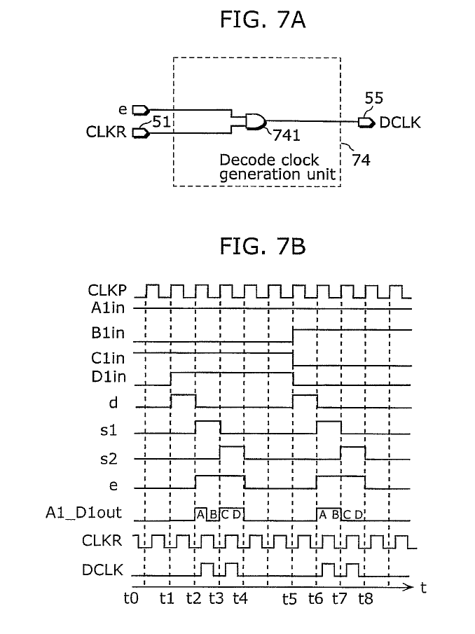

FIG. 7A is a diagram showing a circuit example of the decode clock generation unit 74 according to the first embodiment of the present invention. The decode clock generation unit 74 includes an AND circuit 741. Input signals include the decode control signal e, and a clock 51 obtained by adjusting a phase of the system clock 41 for demultiplexing. Output signals include a decode clock 55.

In the example shown in FIG. 7B, four timing signals (A1in to D1in) are multiplexed in a period of two cycles of the system clock CLKP, and accordingly the decode clock 55 (DCLK) has four edges (two rising edges and two falling edges) in a period from t2 to t4. When the number of signals to be multiplexed is N, the decode clock generation unit 74 generates the decode clock signal having N edges including rising and falling edges, in a section (first enable period) where the signals are multiplexed.

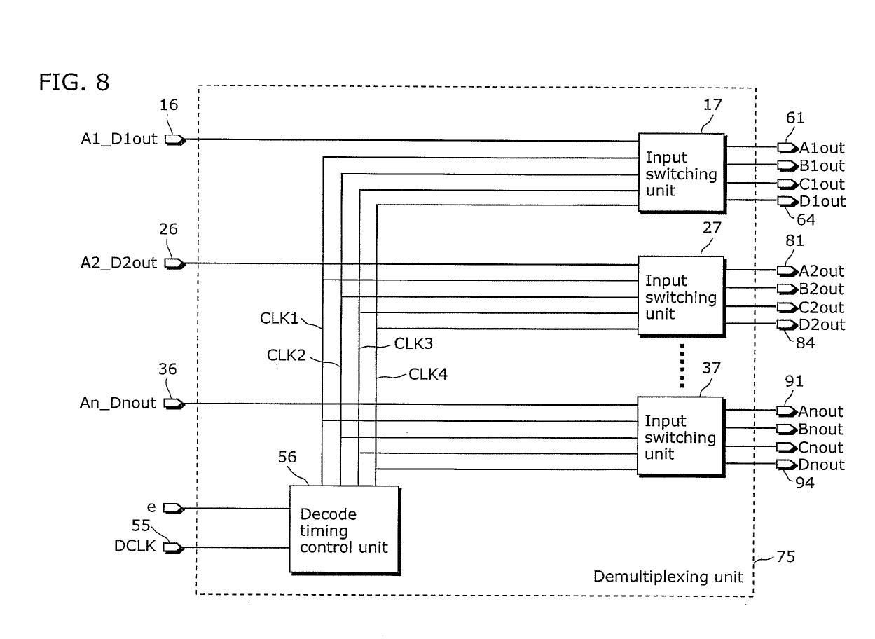

FIG. 8 is a diagram showing a circuit example of the demultiplexing unit 75 according to the first embodiment of the present invention. The demultiplexing unit 75 includes a decode timing control unit 56 and input switching units 17, 27, and 37. Input signals include the multiplexed signals 16, 26, and 36, the decode control signal e, and the decode clock 55. Output signals include CCD drive pulse timing signals 61, 62, 63, 64, 81, 82, 83, 84, 91, 92, 93, and 94.

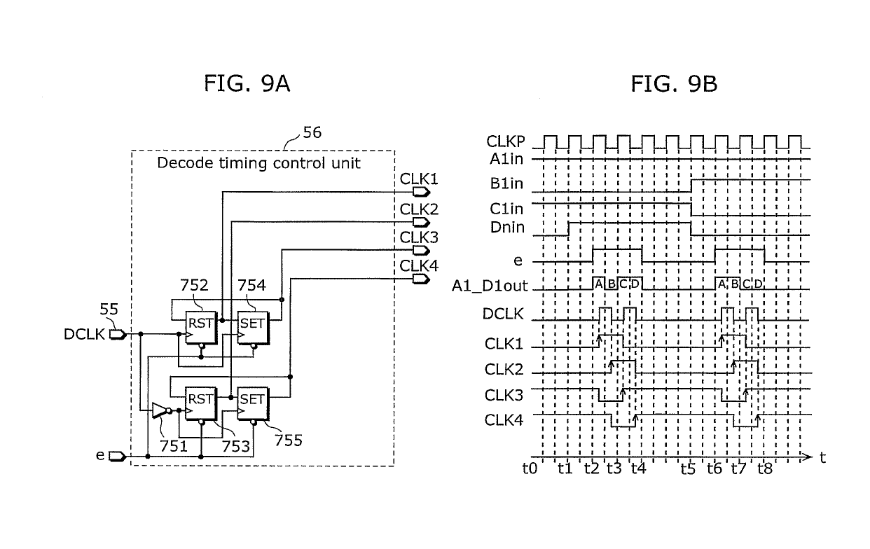

FIG. 9A is a diagram showing a circuit example of the decode timing control unit 56 according to the first embodiment of the present invention. The decode timing control unit 56 includes an inverter 751 and FFs 752, 753, 754, and 755. Input signals include the decode control signal e and the decode clock 55. Output signals include decode timing signals CLK1, CLK2, CLK3, and CLK4. When the decode clock 55 has N edges including rising and falling edges in the section (first enable period) where the signals are multiplexed, the decode timing control unit 56 generates decode timing signals CLK1 to CLKN as many as the edges in the section (first enable period) where the signals are multiplexed.

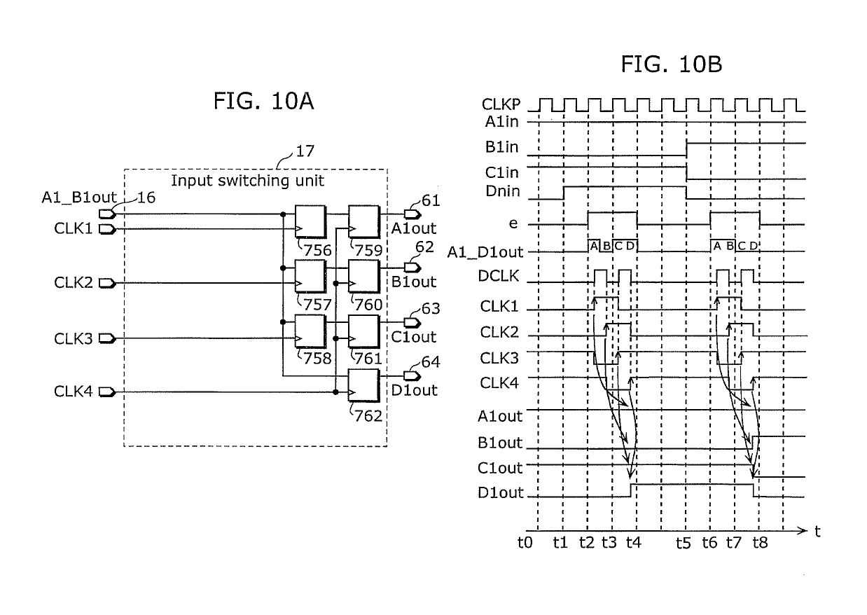

FIG. 10A is a diagram showing a circuit example of the input switching unit 17 according to the first embodiment of the present invention. The input switching unit 17 includes FFs 756, 757, 758, 759, 760, 761, and 762. Input signals include the multiplexed signal 16 and the decode timing signals CLK1, CLK2, CLK3, and CLK4. Output signals include the CCD drive pulse timing signals 61, 62, 63, and 64.

The following describes multiplexing and demultiplexing operations according to the present invention, with reference to drawings.

The signal change detection unit 42 receives the system clock 41 and the input signals 11, 12, . . . , 34 that are synchronized with the system clock 41. The FF 421 holds a logic level of the input signal 11, at a rising edge of the system clock 41. When the input signal 11 has a logic level different from the logic level held in the FF 421, the EXOR 424 outputs HIGH. Likewise, the FFs 422 to 423 respectively hold logic levels of the input signals 12 to 34, at a rising edge of the system clock 41. When the input signals 12 to 34 have logic levels different from the logic levels held in the FFs 422 to 423, the respective EXORs 425 to 426 output HIGH. The OR circuit 427 ORs the outputs of the EXORs 424 to 426, to generate the change detection signal d.

FIG. 4B is a timing chart when any of the signals 11 to 34 to be multiplexed changes in polarity. FIG. 4C is a timing chart when the signals 11 to 34 to be multiplexed change in polarity simultaneously. In either case of FIGS. 4B and 4C, an input signal change can be detected.

The control signal generation unit 43 receives the change detection signal d and the system clock 41. The FFs 431 and 432 hold input logic levels, at a rising edge of the system clock 41. When the change detection signal d is HIGH, the FF 431 outputs HIGH at a rising edge of the system clock 41. While the FF 431 holds HIGH, the FF 432 holds HIGH at a rising edge of the system clock 41. The output of the FF 431 is the time-division control signal s1, the output of the FF 432 is the time-division control signal s2, and the decode control signal e is generated by ORing s1 and s2. FIG. 5B is a timing chart when any of the signals 11 to 34 to be multiplexed changes in polarity. FIG. 5C is a timing chart when the signals 11 to 34 to be multiplexed change in polarity simultaneously. In either case, the time-division control signals s1 and s2 and the decode control signal e can be generated at the next timing to the change of the signal to be multiplexed.

The output switching unit 15 receives the signals 11, 12, 13, and 14 to be multiplexed, the decode control signal e, the system clock 41, and the time-division control signals s1 and s2. When the decode control signal e is HIGH, the AND circuit 151 outputs a logic level of the system clock 41. Based on the output of the AND circuit 151, while the decode control signal e is HIGH, the selector 152 alternately outputs the signals 11 and 12 to be multiplexed, in sync with the system clock 41. Likewise, while the decode control signal e is HIGH, the selector 153 alternately outputs the signals 13 and 14 to be multiplexed, in sync with the system clock 41. The AND circuit 154 outputs a logic level of the selector 152, when the time-division control signal s1 is HIGH. Likewise, the AND circuit 155 outputs a logic level of the selector 153, when the time-division control signal s2 is HIGH. The OR circuit 156 ORs the outputs of the AND circuits 154 and 155.

FIG. 6B is a timing chart when only the signal 14 out of the signals 11, 12, 13, and 14 to be multiplexed changes, and when the signals 12, 13, and 14 change simultaneously. In either case, at the next timing to the change of the input signal, the time-division control signal s1 becomes HIGH and the time-division control signal s2 becomes LOW, as a result of which the output switching unit 15 switches to the output of the AND circuit 154. After one cycle of the system clock 41, the time-division control signal s1 becomes LOW and the time-division control signal s2 becomes HIGH, as a result of which the output switching unit 15 switches to the output of the AND circuit 155. Here, each of the selectors 152 and 153 switches its output in sync with the level of the system clock 41, in a period during which a corresponding one of the time-division control signals s1 and s2 is HIGH. Hence, the signals 11, 12, 13, and 14 can be time-division multiplexed in two cycles of the system clock 41 and outputted.

In FIG. 6B, the period during which the decode control signal e (first control signal) is HIGH is the first enable period. As shown in FIG. 6B, the signals 11 to 14 (A1in to D1in) are multiplexed at timings A to D designated at a multiplexed signal A1_D1out.

The decode clock generation unit 74 receives the clock 51 obtained by adjusting the phase of the system clock 41 for demultiplexing, and the decode control signal e. The AND circuit 741 outputs the clock 51 as the decode clock 55, while the decode control signal e is HIGH.

FIG. 9 is a diagram showing a circuit example of the decode timing control unit 56 in the demultiplexing unit 75 shown in FIG. 8. The decode timing control unit 56 receives the decode clock 55 and the decode control signal e. The reset FF 752 and the set FF 754 each hold an input logic level at a rising edge of the decode clock 55. The inverter 751 outputs an inverted logic level of the decode clock 55. The reset FF 753 and the set FF 755 each hold an input logic level at a falling edge of the decode clock 55. Thus, when the decode control signal e is HIGH and the FFs 752, 753, 754, and 755 are in operation, rising and falling edges included in two cycles of the decode clock 55 are converted to four rising edges of the respective decode timing signals CLK1, CLK2, CLK3, and CLK4.

FIG. 10 is a diagram showing a circuit example of the input switching unit 17 in the demultiplexing unit 75 shown in FIG. 8. The input switching unit 17 receives the multiplexed signal 16 and the decode timing signals CLK1, CLK2, CLK3, and CLK4. The FFs 756, 757, 758, and 762 hold a logic level of the multiplexed signal 16, respectively at rising edges of the decode timing signals CLK1, CLK2, CLK3, and CLK4. The FFs 759, 760, and 761 respectively hold output logic levels of the FFs 756, 757, and 758, at a rising edge of the decode timing signal CLK4.

As a result of the above operation, timing constraints of signals to be multiplexed are alleviated, and not only two signals but also three or more signals can be time-division multiplexed and transmitted between the first semiconductor device and the second semiconductor device. Which is to say, in the first enable period that is k times as long as one cycle of the system clock signal (k is an integer that is equal to or larger than N/2 and is closest to N/2, and N is the number of timing signals), two signals are time-division multiplexed per cycle of the system clock signal. Thus, the number N of signals to be multiplexed can be set to an arbitrary number equal to or larger than three. Moreover, since a CCD drive pulse typically requires a high voltage, the second semiconductor device that supplies the timing signals to the solid-state imaging device can be operated with a high voltage, whereas the first semiconductor device that generates and multiplexes the timing signals can be operated with a low voltage. Furthermore, the timing signals are not constantly multiplexed, but multiplexed only when a level change is detected. This contributes to power saving.

### Second Embodiment

A second embodiment of the present invention describes a structure example of a CCD charge transfer drive device that multiplexes each of a plurality of timing signal groups.

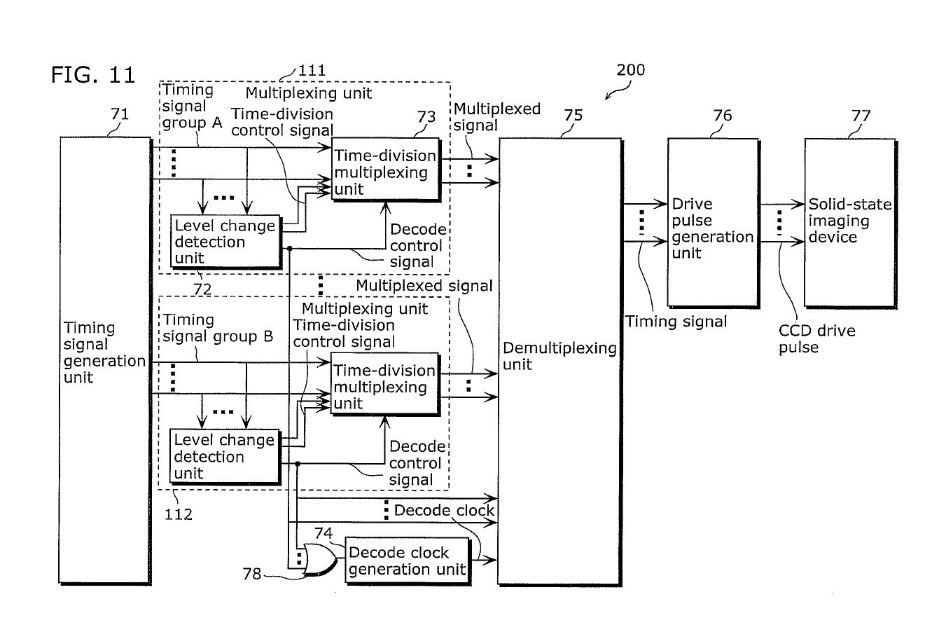

FIG. 11 is a block diagram schematically showing the CCD charge transfer drive device according to the second embodiment of the present invention. A CCD charge transfer drive device 200 shown in FIG. 11 includes: the timing signal generation unit 71; multiplexing units 111 and 112 each including the level change detection unit 72 and the time-division multiplexing unit 73; an OR circuit 78; the decode clock generation unit 74; the demultiplexing unit 75; the drive pulse generation unit 76; and the solid-state imaging device 77. In the example shown in FIG. 11, the multiplexing unit 111 receives a timing signal group A in which a shortest duration from one level change to the next level change of a timing signal corresponds to one cycle of the system clock 41. Likewise, the multiplexing unit 112 receives a timing signal group B in which a shortest duration from one level change to the next level change of a timing signal corresponds to two cycles of the system clock 41. The multiplexing units 111 and 112 respectively receive the timing signal groups A and B that differ in duration from one level change to the next level change of a timing signal, and multiplex different numbers of signals. In the second embodiment, a decode clock can be generated in the decode clock generation unit 74 as in the first embodiment.

Though two multiplexing units are included in the CCD charge transfer drive device in FIG. 11, three or more multiplexing units may be included in the CCD charge transfer drive device. Besides, though each multiplexing unit supplies one decode control signal to the demultiplexing unit in FIG. 11, two or more multiplexing units may share one decode control signal, thereby reducing the number of signal lines.

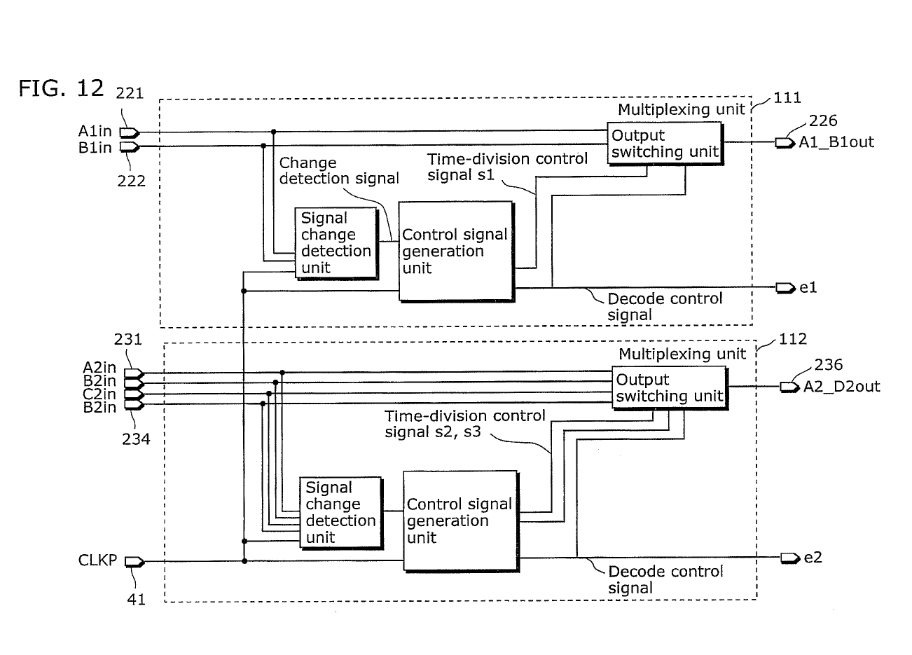

FIG. 12 is a diagram showing a circuit example of the two-signal multiplexing unit 111 and the four-signal multiplexing unit 112. Though one multiplexed signal is generated from each of the multiplexing units 111 and 112 in FIG. 12, two or more multiplexed signals may be generated from each of the multiplexing units 111 and 112.

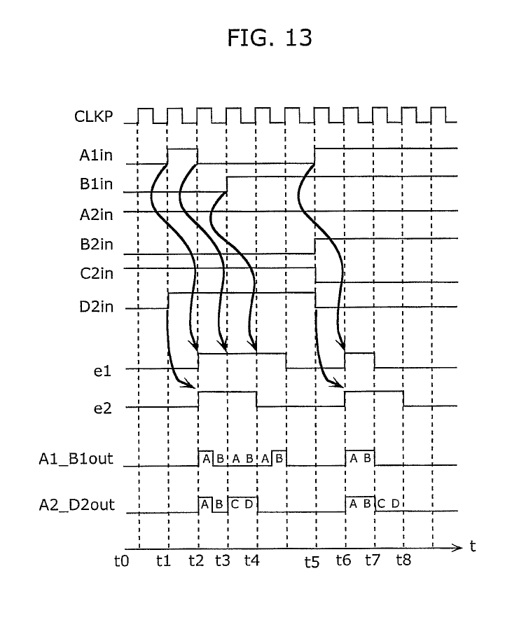

FIG. 13 is a timing chart when the time-division multiplexing units shown in FIG. 12 perform multiplexing. Since the multiplexing units 111 and 112 perform multiplexing using the same system clock 41, the two-signal multiplexing unit 111 performs multiplexing in half a period of the four-signal multiplexing unit 112.

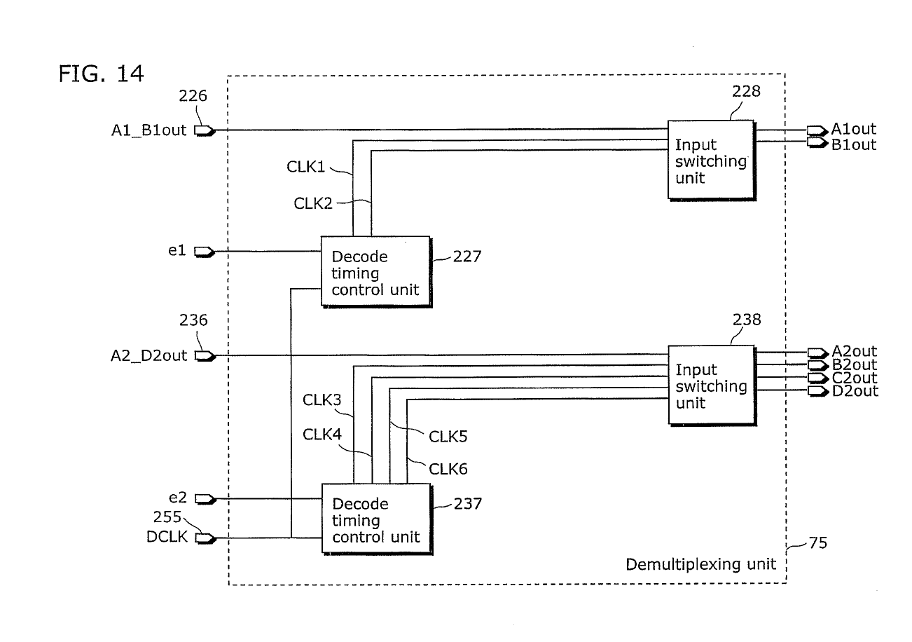

FIG. 14 is a block diagram schematically showing the demultiplexing unit 75 according to the second embodiment of the present invention.

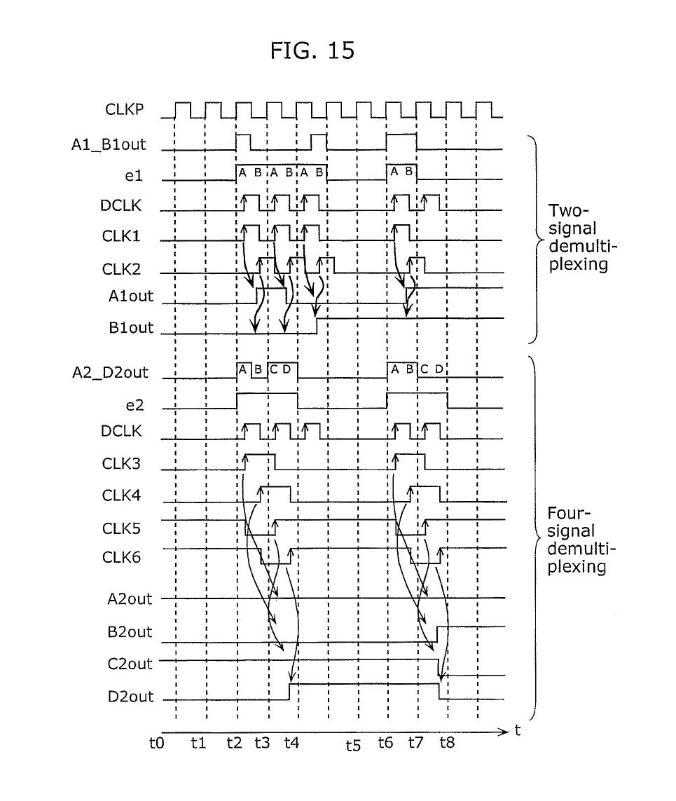

FIG. 15 is a timing chart when the demultiplexing unit 75 shown in FIG. 14 performs demultiplexing. The demultiplexing unit 75 receives multiplexed signals 226 and 236, decode control signals e1 and e2, and a decode clock 255. A decode timing control unit 227 outputs decode timing signals CLK1 and CLK2 for two-signal demultiplexing, based on the decode control signal e1. An input switching unit 228 holds a logic level of the multiplexed signal 226 at rising edges of the decode timing signals CLK1 and CLK2, and outputs drive timing signals A1out and B1out at a rising edge of the decode timing signal CLK2. In the same manner, the decode timing control unit 237 outputs decode timing signals CLK3, CLK4, CLK5, and CLK6 for four-signal demultiplexing, based on the decode control signal e2. An input switching unit 238 holds a logic level of the multiplexed signal 236 at rising edges of the decode timing signals CLK3, CLK4, CLK5, and CLK6, and outputs drive timing signals A1out, B2out, C2out, and D2out at a rising edge of the decode timing signal CLK6. According to the above operation, for each of two or more timing signal groups classified according to a duration from one level change to the next level change of a timing signal, a multiplexing unit that multiplexes a different number of signals of the corresponding timing signal group is provided. This allows multiplexing of an optimum number of signals for a level change frequency of the signals.

As described above, the number N of signals to be multiplexed as the first timing signal group and the number M of signals to be multiplexed as the second timing signal group can be separately determined. When the number of signals to be multiplexed is larger, a longer period (enable period) is required for multiplexing. Therefore, a larger number of signals can be multiplexed for timing signals of a lower rate (lower frequency). Conversely, when the number of signals to be multiplexed is smaller, a shorter period (enable period) is required for multiplexing. Therefore, a smaller number of signals can be multiplexed for timing signals of a higher rate (higher frequency). In other words, by classifying timing signals into the first timing signal group and the second timing signal group according to the timing signal rate, a multiplexed signal obtained by multiplexing a smaller number of higher-rate timing signals and a multiplexed signal obtained by multiplexing a larger number of lower-rate timing signals can both be generated, with it being possible to achieve a balance between the required rate and the number of signals to be multiplexed.

Moreover, by classifying higher-rate timing signals as the first timing signal group and lower-rate timing signals as the second timing signal group, it is possible to balance the required rate and the number of signals to be multiplexed for each of the first and second timing signal groups.

Here, the first timing signal group may be a timing signal group for transfer operations of the plurality of vertical CCDs, wherein the second timing signal group is a timing signal group for signal charge reading operations from the plurality of light receiving elements to the plurality of vertical CCDs. According to this structure, since the transfer operations of the plurality of vertical CCDs are faster than the signal charge reading operations from the plurality of light receiving elements to the plurality of vertical CCDs, an appropriate balance can be achieved between the required rate and the number of signals to be multiplexed for each of the first and second timing signal groups.

### Third Embodiment

In a third embodiment of the present invention, the first timing signal group with a smaller number of signals to be multiplexed is multiplexed in a third enable period. The third enable period is represented by logical OR of the first enable period and a second enable period. Meanwhile, the second timing signal group with a larger number of signals to be multiplexed is multiplexed in the second enable period. This makes it possible to reduce the number of signal lines (decode control signals (control signals) and decode clocks) between the time-division multiplexing unit and the demultiplexing unit. In particular, in the case where the time-division multiplexing unit and the demultiplexing unit are formed as semiconductor devices of separate chips, the number of terminals of each semiconductor device can be reduced, which contributes to lower cost.

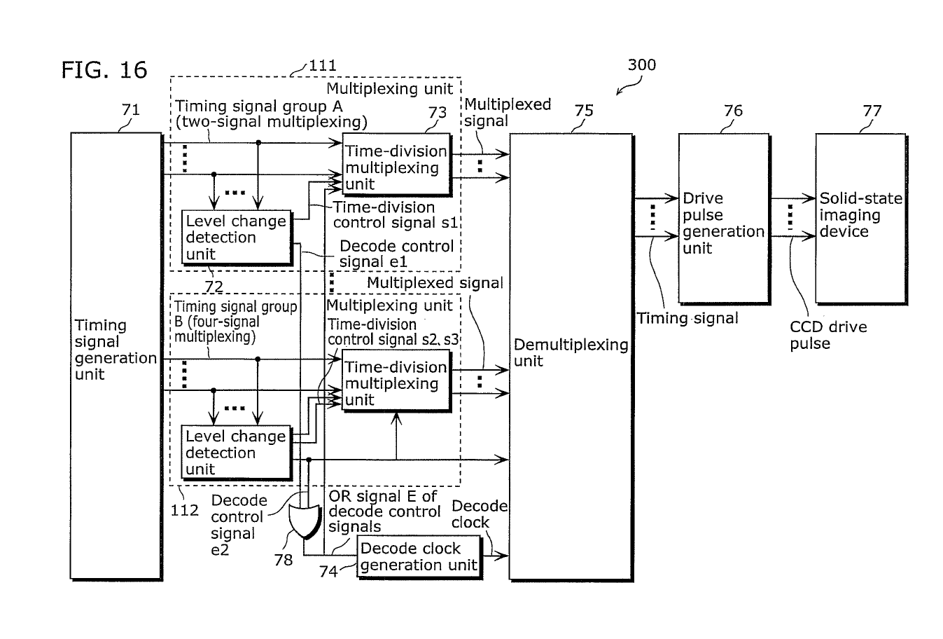

FIG. 16 is a block diagram schematically showing a CCD charge transfer drive device according to the third embodiment of the present invention. A CCD charge transfer drive device 300 shown in FIG. 16 includes: the timing signal generation unit 71; the multiplexing units 111 and 112 each including the level change detection unit 72 and the time-division multiplexing unit 73; the OR circuit 78; the decode clock generation unit 74; the demultiplexing unit 75; and the drive pulse generation unit 76, and outputs CCD drive pulses for driving the solid-state imaging device 77. The first timing signal group A of the multiplexing unit 111 is a group of two signals to be multiplexed, whereas the second timing signal group B of the multiplexing unit 112 is a group of four signals to be multiplexed.

The level change detection unit 72 in the multiplexing unit 111 detects a level change of any of the signals in the first timing signal group A, and outputs the decode control signal e1 and the time-division control signal s1.

Likewise, the level change detection unit 72 in the multiplexing unit 112 detects a level change of any of the signals in the second timing signal group B, and outputs the decode control signal e2 and the time-division control signals s2 and s3.

The time-division multiplexing unit 73 in the multiplexing unit 111 receives the time-division control signal s1 and an OR signal E of the decode control signals e1 and e2 outputted from the OR circuit 78, and performs two-signal multiplexing of the first timing signal group A in a period indicated by the OR signal E. On the other hand, the time-division multiplexing unit 73 in the multiplexing unit 112 receives the time-division control signals s2 and s3 and the decode control signal e2, and performs four-signal multiplexing of the second timing signal group B in a period indicated by the decode control signal e2.

The decode clock generation unit 74 outputs a decode clock, in the period indicated by the OR signal E of the decode control signals e1 and e2.

The demultiplexing unit 75 demultiplexes a four-signal multiplexed signal of the second timing signal group B according to the decode clock, only in the period indicated by the decode control signal e2. Meanwhile, a two-signal multiplexed signal of the first timing signal group A can be demultiplexed into the original timing signals with only the decode clock, and so the decode control signal can be omitted.

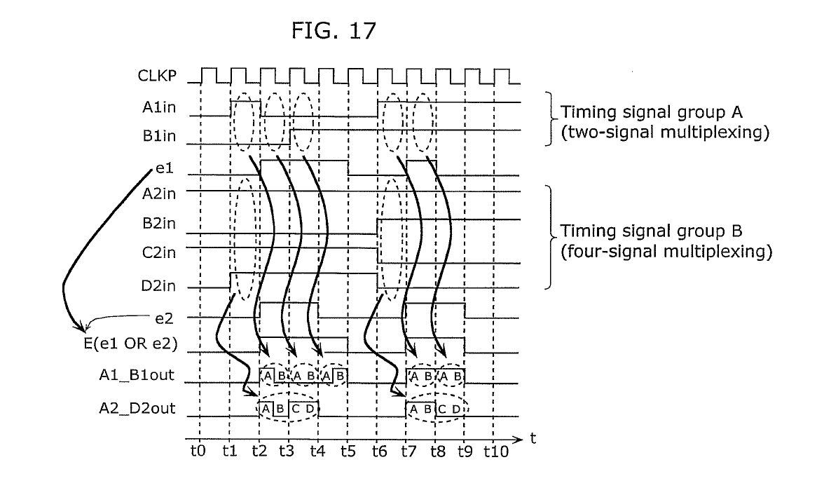

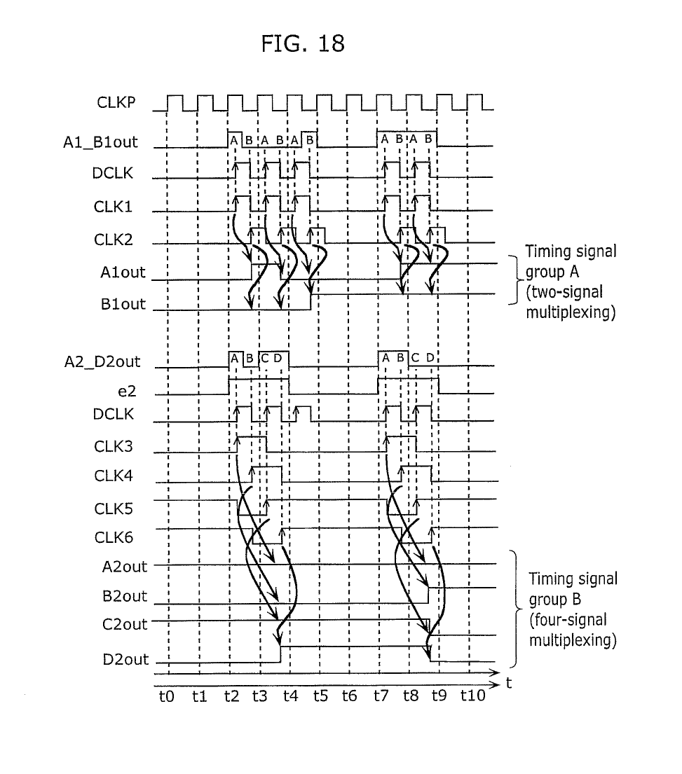

The following describes an application example of the circuit shown in FIG. 16, with reference to timing charts shown in FIGS. 17 and 18. An application example where the multiplexing unit 111 multiplexes the first timing signal group made up of N (N=2 in FIG. 17) timing signals and the multiplexing unit 112 multiplexes the second timing signal group made up of M (M=4 in FIG. 17) timing signals is described below.

The timing signal generation unit 71 generates the first timing signal group including the N timing signals, and the second timing signal group including the M timing signals. For instance, the first timing signal group is a timing signal group for transfer operations of the plurality of vertical CCDs, whereas the second timing signal group is a timing signal group for signal charge reading operations from the plurality of light receiving elements to the plurality of vertical CCDs.

The signal change detection unit 42 in the level change detection unit 72 in the multiplexing unit 111 detects a level change of any timing signal in the first timing signal group. Meanwhile, the signal change detection unit 42 in the level change detection unit 72 in the multiplexing unit 112 detects a level change of any timing signal in the second timing signal group.

When the level change of the timing signal in the first timing signal group is detected, the control signal generation unit 43 in the level change detection unit 72 in the multiplexing unit 111 generates the first control signal (decode control signal e1) indicating the first enable period that is k times as long as one cycle of the system clock signal. When the level change of the timing signal in the second timing signal group is detected, the control signal generation unit 43 in the level change detection unit 72 in the multiplexing unit 112 generates a second control signal (decode control signal e2) indicating the second enable period that is h times as long as one cycle of the system clock signal (h is an integer that is equal to or larger than M/2 and is closest to M/2, and M is the number of timing signals in the second timing signal group). The OR circuit 78 shown in FIG. 16 ORs the first control signal (decode control signal e1) and the second control signal (decode control signal e2), to generate a third control signal indicating the third enable period represented by logical OR of the first enable period and the second enable period.

The time-division multiplexing unit 73 in the multiplexing unit 111 time-division multiplexes the N timing signals in the first timing signal group in the third enable period by time-division multiplexing two signals per cycle of the system clock signal, to generate a first time-division multiplexed signal. The time-division multiplexing unit 73 in the multiplexing unit 112 time-division multiplexes the M timing signals in the second timing signal group in the second enable period by time-division multiplexing two signals per cycle of the system clock signal, to generate a second time-division multiplexed signal.

The decode clock generation unit 74 need not be provided separately for each of the multiplexing units 111 and 112, but are shared between the multiplexing units 111 and 112. That is, the decode clock generation unit 74 generates the decode clock based on the third control signal mentioned above. This allows the number of decode control signals (control signals) and decode clocks between the demultiplexing unit 75 and the multiplexing units 111 and 112 to be reduced.

The demultiplexing unit 75 demultiplexes the first time-division multiplexed signal into the N timing signals and demultiplexes the second time-division multiplexed signal into the M timing signals, based on the third control signal.

FIG. 17 is a timing chart when the multiplexing units 111 and 112 shown in FIG. 16 perform multiplexing.

Though there is no level change in the first timing signal group A at t7, a level change in the second timing signal group B causes the OR signal E outputted from the OR circuit 78 to become HIGH, so that the multiplexing unit 111 performs multiplexing.

On the other hand, the second timing signal group B is multiplexed only when the decode control signal e2 is HIGH.

FIG. 18 is a timing chart when the demultiplexing unit 75 shown in FIG. 16 demultiplexes the multiplexed signals shown in FIG. 17. The demultiplexing unit 75 demultiplexes the two-signal multiplexed signal A1_B1out, in a period during which the decode clock is being received. At t8, the decode clock is redundantly received but there is no level change in demultiplexed signals A1out and B1out. Thus, the original timing signals shown in FIG. 17 can be obtained.

On the other hand, the demultiplexing unit 75 demultiplexes the four-signal multiplexed signal A2_D2out, in a period during which the decode control signal e2 is HIGH. Thus, the original timing signals can be obtained.

As described above, by performing redundant multiplexing, a decode control signal for a multiplexing unit that multiplexes a smaller number of signals can be omitted, with it being possible to further reduce the number of signal lines.

Although the CCD charge transfer drive device according to the present invention has been described by way of the above embodiments, the present invention is not limited to the above embodiments. Modifications obtained by applying various changes conceivable by those skilled in the art to the embodiments and any combinations of components in different embodiments are also included in the present invention without departing from the scope of the present invention.

### INDUSTRIAL APPLICABILITY

The time-division multiplexing circuit described above can alleviate timing constraints of signal changes between input signals to be multiplexed. This improves flexibility in the number and combination of signals to be time-division multiplexed.

What is claimed is:

1. A CCD charge transfer drive device that drives a solid-state imaging device including: a plurality of light receiving elements arranged two-dimensionally; a plurality of vertical CCDs; and a horizontal CCD, said CCD charge transfer drive device comprising:
a timing signal generation unit configured to generate a first timing signal group that includes N timing signals representing CCD drive pulses;
a change detection unit configured to detect a level change of any of the N timing signals;
a control signal generation unit configured to generate a first control signal when said change detection unit detects the level change of any of the N timing signals, the first control signal indicating a first enable period that is k times as long as one cycle of a system clock signal, where k is an integer that is equal to or larger than N/2 and is closest to N/2;
a time-division multiplexing unit configured to time-division multiplex the N timing signals in the first enable period by time-division multiplexing two signals per cycle of the system clock signal, to generate a first time-division multiplexed signal;
a decode clock generation unit configured to generate a decode clock used for demultiplexing; and
a demultiplexing unit configured to demultiplex the first time-division multiplexed signal into the N timing signals, using the decode clock.

2. The CCD charge transfer drive device according to claim 1, comprising:
a one-chip first semiconductor device; and
a one-chip second semiconductor device,
wherein said first semiconductor device includes said timing signal generation unit, said change detection unit, said control signal generation unit, said decode clock generation unit, and said time-division multiplexing unit, and
said second semiconductor device includes said demultiplexing unit, and supplies the N timing signals to the solid-state imaging device.

3. The CCD charge transfer drive device according to claim 1,
wherein said control signal generation unit is configured to generate the first control signal indicating the first enable period, only when said change detection unit detects the level change of any of the N timing signals,
said time-division multiplexing unit is configured to time-division multiplex the N timing signals, only in the first enable period indicated by the first control signal, and
said demultiplexing unit is configured to demultiplex the first time-division multiplexed signal, only in the first enable period indicated by the first control signal.

4. The CCD charge transfer drive device according to claim 1,
wherein said timing signal generation unit is configured to further generate a second timing signal group that includes M timing signals of a lower rate than the first timing signal group,
said change detection unit is configured to further detect a level change of any of the M timing signals,
said control signal generation unit is configured to further generate a second control signal when said change detection unit detects the level change of any of the M timing signals, the second control signal indicating a second enable period that is h times as long as one cycle of the system clock signal, where h is an integer that is equal to or larger than M/2 and is closest to M/2,
said time-division multiplexing unit is configured to further time-division multiplex the M timing signals in the second enable period by time-division multiplexing two signals per cycle of the system clock signal, to generate a second time-division multiplexed signal, and
said demultiplexing unit is configured to further demultiplex the second time-division multiplexed signal into the M timing signals.

5. The CCD charge transfer drive device according to claim 4,
wherein M is larger than N.

6. The CCD charge transfer drive device according to claim 5,
wherein the first timing signal group is a timing signal group for transfer operations of the plurality of vertical CCDs, and
the second timing signal group is a timing signal group for signal charge reading operations from the plurality of light receiving elements to the plurality of vertical CCDs.

7. The CCD charge transfer drive device according to claim 5,
wherein said control signal generation unit is configured to further generate a third control signal indicating a third enable period that is represented by logical OR of the first enable period and the second enable period,
said time-division multiplexing unit is configured to: time-division multiplex the N timing signals included in the first timing signal group in the third enable period by time-division multiplexing two signals per cycle of the system clock signal, to generate the first time-division multiplexed signal; and time-division multiplex the M timing signals included in the second timing signal group in the second enable period by time-division multiplexing two signals per cycle of the system clock signal, to generate the second time-division multiplexed signal, and
said demultiplexing unit is configured to, based on the third control signal, demultiplex the first time-division multiplexed signal into the N timing signals, and demultiplex the second time-division multiplexed signal into the M timing signals.

8. A semiconductor device that generates CCD drive pulses for a solid-state imaging device including: a plurality of light receiving elements arranged two-dimensionally; a plurality of vertical CCDs; and a horizontal CCD, said semiconductor device comprising:
a timing signal generation unit configured to generate N timing signals that represent the CCD drive pulses, where N is an integer equal to or larger than three;
a change detection unit configured to detect a level change of any of the N timing signals;
a control signal generation unit configured to generate a first control signal when said change detection unit detects the level change of any of the N timing signals, the first control signal indicating a first enable period that is k times as long as one cycle of a system clock signal, where k is an integer that is equal to or larger than N/2 and is closest to N/2;
a time-division multiplexing unit configured to time-division multiplex the N timing signals in the first enable period by time-division multiplexing two signals per cycle of the system clock signal, to generate a first time-division multiplexed signal; and
a decode clock generation unit configured to generate a decode clock used for demultiplexing.

9. A semiconductor device that generates CCD drive pulses for a solid-state imaging device including: a plurality of light receiving elements arranged two-dimensionally; a plurality of vertical CCDs; and a horizontal CCD, said semiconductor device comprising:
a reception unit configured to receive a first time-division multiplexed signal generated by time-division multiplexing N timing signals representing the CCD drive pulses, where N is an integer equal to or larger than three; and
a demultiplexing unit configured to demultiplex the first time-division multiplexed signal into the N timing signals in a first enable period that is k times as long as one cycle of a system clock signal where k is an integer that is equal to or larger than N/2 and is closest to N/2, the N timing signals having been time-division multiplexed by time-division multiplexing two signals per cycle of the system clock signal.
